(19) United States
(12) Patent Application Publication
(10) Pub. No.: US 2021/0213742 A1
(43) Pub. Date: Jul. 15, 2021

(54) LIQUID EJECTION APPARATUS AND WASTE LIQUID CONTAINER

(71) Applicant: Canon Kabushiki Kaisha, Tokyo (JP)

(72) Inventors: Keiji Watanabe, Kanagawa (JP); Kenji Tamamori, Kanagawa (JP); Takashi Sugawara, Kanagawa (JP)

(21) Appl. No.: 17/147,809

(22) Filed: Jan. 13, 2021

(30) Foreign Application Priority Data
Jan. 15, 2020 (JP) 2020-004211

(51) Int. Cl. B41J 2/17

(52) U.S. Cl. CPC B41J 2/1721; B41J 2002/1728

(57) ABSTRACT

Provided are a liquid ejection apparatus and a waste liquid container. The liquid ejection apparatus having a liquid ejection head includes an attachment portion to which a waste liquid container for storing a waste liquid collected from the liquid ejection head is fitted and attached in a detachable manner. The attachment portion is formed as an opening formed in the casing and a recess continuous from the opening, and an attaching direction of the waste liquid container when being attached is defined as a first direction. A discharging portion for outputting the collected waste liquid to the waste liquid container is formed at a position on the inward side of the casing along the first direction with respect to a position bisecting a length along the first direction of a region occupied by the attached waste liquid container. The discharging portion faces a direction orthogonal to the first direction.

### BACKGROUND OF THE INVENTION

### Field of the Invention

The present invention relates to a liquid ejection apparatus and a waste liquid container used in the liquid ejection apparatus.

### Description of the Related Art

In a liquid ejection apparatus that ejects a liquid such as ink to a medium such as a recording medium from a liquid ejection head, since a liquid that was not ejected to the medium is discharged from a liquid ejection head, a waste liquid container that stores the discharged liquid as a waste liquid is provided. The waste liquid container is attached to an attachment portion provided in the liquid ejection apparatus in a detachable manner. A discharging portion that discharges a waste liquid to the waste liquid container is provided to the attachment portion. A waste liquid discharged from the discharging portion may spill out of the periphery of the discharging portion and soil the interior of the liquid ejection apparatus or the exterior of the waste liquid container, and to address this, Japanese Patent Application Laid-Open No. 2018-202648 discloses a waste liquid container that can suppress a waste liquid from spilling out of a discharging portion of the liquid ejection head when the waste liquid container is being attached.

Although a waste liquid container is attached to the liquid ejection apparatus in a detachable manner, the discharging portion may be exposed in the liquid ejection apparatus when the waste liquid container is being attached or detached, and a user may touch this exposed discharging portion and contact with the waste liquid.

### SUMMARY OF THE INVENTION

A liquid ejection apparatus of the present invention includes: a casing; a liquid ejection head that ejects a liquid; and an attachment portion to which a waste liquid container used for storing a waste liquid discharged from the liquid ejection head is fitted and attached in a detachable manner. The attachment portion has an opening formed in an outer side surface of the casing and a recess continuous with the opening and is structured such that an attaching direction of the waste liquid container when the waste liquid container is being attached to the attachment portion is defined as a first direction. In the attachment portion, a discharging portion used for outputting the waste liquid to the waste liquid container is formed at a position on an inward side of the casing along the first direction with respect to a position bisecting a length along the first direction of a region occupied by the waste liquid container fitted and attached to the attachment portion. The discharging portion faces a direction orthogonal to the first direction.

Further features of the present invention will become apparent from the following description of exemplary embodiments with reference to the attached drawings.

### BRIEF DESCRIPTION OF THE DRAWINGS

FIG. 1 is a perspective view illustrating an overall configuration of a liquid ejection apparatus.

FIG. 2 is a schematic diagram illustrating a maintenance unit provided to the liquid ejection apparatus.

FIG. 3A and FIG. 3B are perspective views illustrating a conventional waste liquid container.

FIG. 4 is a diagram illustrating a liquid ejection apparatus of a first embodiment of the present invention.

FIG. 5 is a diagram illustrating a liquid ejection apparatus of a second embodiment of the present invention.

FIG. 6 is a diagram illustrating a liquid ejection apparatus of a third embodiment of the present invention.

### DESCRIPTION OF THE EMBODIMENTS

The object of the present invention is to provide a liquid ejection apparatus structured such that the user is less likely to touch a discharging portion of a waste liquid when attaching or detaching a waste liquid container or the like and to provide a waste liquid container adapted for such a liquid ejection apparatus.

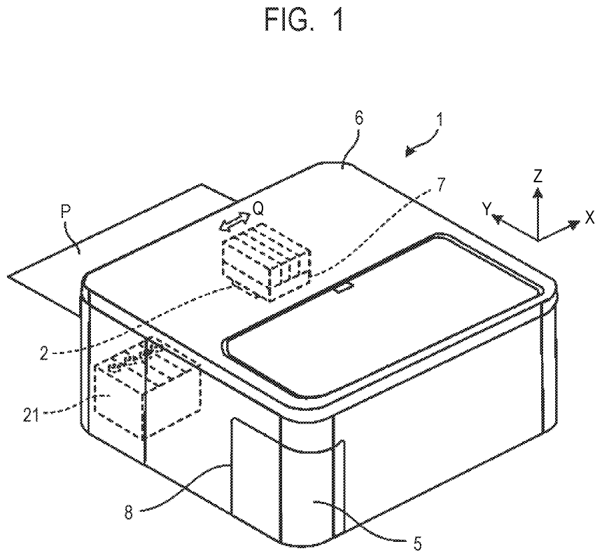

Embodiments of the present invention will be described with reference to the drawings. Before the liquid ejection apparatus based on the present invention is described, a general configuration of a liquid ejection apparatus will be described with reference to FIG. 1. The liquid ejection apparatus 1 is to eject a liquid such as ink used for recording to a medium P or the like, for example, while conveying the medium P such as paper in a predetermined direction and has a casing 6. The casing 6 has substantially a rectangular parallelepiped shape whose lateral direction is the longitudinal direction in general and thus defines an X-axis, a Y-axis, and a Z-axis that are orthogonal to each other in association with the sides of the casing 6. When it is assumed that the medium P is conveyed from the front side of the liquid ejection apparatus 1 and fed to the inside of the casing 6, the X-axis is an axis in a lateral direction of the liquid ejection apparatus 1, the Y-axis is an axis in the depth direction of the liquid ejection apparatus 1 itself, and the Z-axis is an axis in the height direction in a normal installation state of the liquid ejection apparatus 1. The conveyance direction of the medium P on the front side of the liquid ejection apparatus 1 is the −Y direction.

A carriage 7 is provided inside the casing 6 so as to be able to reciprocally move as indicated by the arrow Q in the drawing in the ±X directions corresponding to the main scan direction above a conveyance region that is a region in which the medium P is conveyed when recording is performed. A liquid ejection head 2 that ejects a liquid to the medium P conveyed toward the −Y direction in the conveyance region is mounted on the lower side of the carriage 7. Furthermore, a tank 21 that stores a liquid in order to supply the liquid to the liquid ejection head 2 is provided inside the casing 6. A flexible liquid supply tube (not illustrated) is drawn out from the tank 21, and the end on the downstream side of the liquid supply tube is connected to a tube connection portion (not illustrated) provided to the upper part of the carriage 7. A liquid supply path (not illustrated) used for supplying a liquid to the liquid ejection head 2 from this tube connection portion is provided inside the carriage 7.

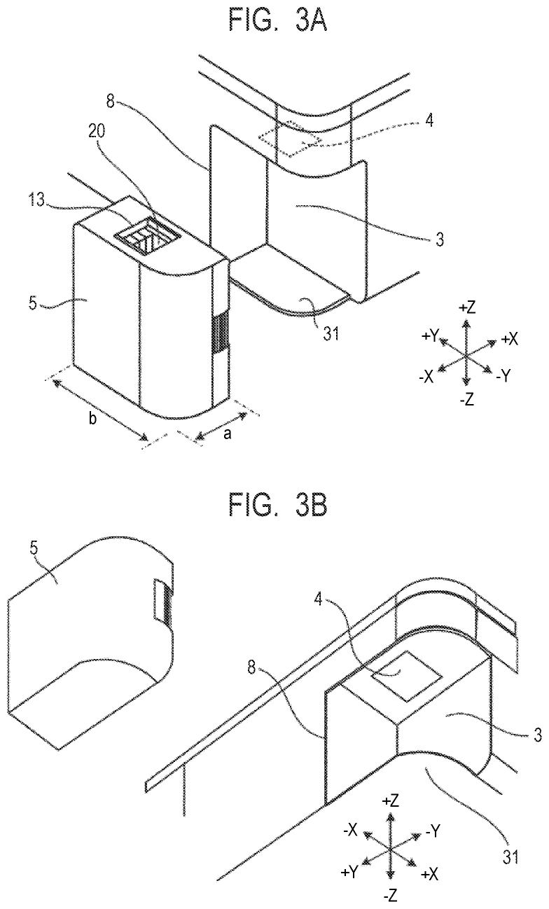

An opening 8 is formed on the outer side surface of the casing 6, and a waste liquid container 5 is fitted and attached in a detachable manner to a recessed portion made by the opening 8. The recessed portion formed by the opening 8 for attaching the waste liquid container 5 is referred to as an attachment portion 3 (see FIG. 3A and FIG. 3B). To address that a liquid not ejected to the medium P is generated as a waste liquid from the liquid ejection head 2, the waste liquid container 5 is provided in order to store the waste liquid generated by the liquid ejection head 2. Note that the configuration having the detachable waste liquid container 5 is particularly effective in the liquid ejection apparatus 1 in which a continuous liquid supply system that can refill the tank 21 provided to the liquid ejection apparatus 1 with a liquid from a refill container such as a bottle is mounted. This is because, in such the liquid ejection apparatus 1, a larger amount of liquid tends to be used than in the conventional one, and a larger amount of waste liquid is discharged accordingly, however, with the waste liquid container 5 being configured to be detachable, it is possible to discharge a larger amount of waste liquid by replacement of the waste liquid container 5. A maintenance unit 9 and the waste liquid container 5 provided to the liquid ejection apparatus 1 in order to collect a waste liquid generated by the liquid ejection head 2 will be described below.

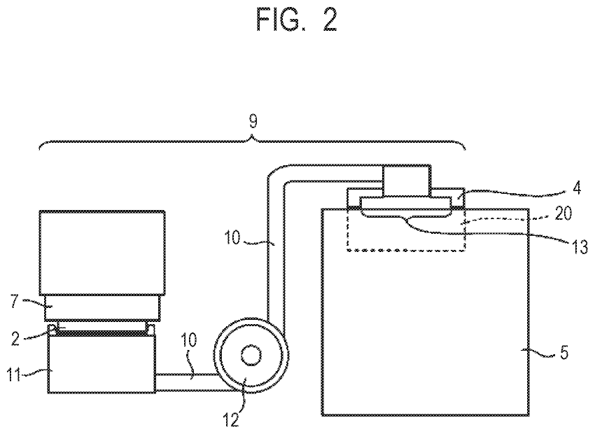

FIG. 2 illustrates the maintenance unit 9. The maintenance unit 9 has a cap 11 that accepts a waste liquid discharged from the liquid ejection head 2. The cap 11 is provided in association with the position of the end of the range of reciprocal movement in the main scan direction of the carriage 7, for example, and is configured to be able to cover the face that ejects a liquid of the liquid ejection head 2 mounted on the carriage 7. A waste liquid tube 10 used for sucking the waste liquid out of the cap 11 is connected to a pump 12. In response to activation of the pump 12, the waste liquid is sucked out from the liquid ejection head 2 to the cap 11, and this waste liquid is sucked out from the cap 11 into the waste liquid tube 10. As the pump 12, a tube pump is used, for example. In the maintenance unit 9, the end on the downstream side of the waste liquid tube 10 is connected to a discharging portion 4 that serves as a connection portion to the waste liquid container 5. The discharging portion 4 is provided to the liquid ejection apparatus 1 so as to face a waste liquid inlet 13 of the waste liquid container 5 with the waste liquid container 5 being attached to the attachment portion 3. As a result, the waste liquid sucked through the waste liquid tube 10 from the cap 11 in response to the activation of the pump 12 is output from the discharging portion 4 to the waste liquid container 5.

FIG. 3A and FIG. 3B are diagrams illustrating a conventional waste liquid container 5 and illustrate a state where the waste liquid container 5 is detached from the attachment portion 3 of the liquid ejection apparatus 1. FIG. 3A is a perspective view of the waste liquid container 5 when viewed diagonally from the top, and FIG. 3B is a perspective view of the waste liquid container 5 when viewed diagonally from the bottom. In the depicted waste liquid container, the opening 8 is formed at a position where adjacent two outer side surfaces of the casing 6 of the liquid ejection apparatus 1 are connected to each other, and the waste liquid container 5 is fitted and attached to the attachment portion 3 made by the opening 8. While the waste liquid container 5 also has substantially a rectangular parallelepiped shape having sides parallel to the X-axis, the Y-axis, and the Z-axis, respectively, the length “b” in the Y-axis direction is longer than the length “a” in the X-axis direction. The opening 8 is not formed to and leaves the bottom of the casing 6, and a bottom wall 31 that holds the waste liquid container 5 against the gravity is formed of a member forming the bottom of the casing 6 in the attachment portion 3. Therefore, it is possible to attach the waste liquid container 5 to the attachment portion 3 both by moving the waste liquid container 5 in the +X direction in the drawing or by moving the waste liquid container 5 in the +Y direction in the drawing. A waste liquid storage chamber (not illustrated) that stores the waste liquid is provided inside the waste liquid container 5. The waste liquid inlet 13 that is an inlet of a waste liquid input chamber 20 communicating with the waste liquid storage chamber is provided as an opening in substantially the center of the upper surface of the waste liquid container 5 (the surface facing the +Z direction). The discharging portion 4 is provided inside the attachment portion 3 in the liquid ejection apparatus 1 as described above, and in a state where the waste liquid container 5 is attached to the attachment portion 3, the discharging portion 4 is located right above in the +Z direction of the waste liquid inlet 13 of the waste liquid container 5. Further, the waste liquid discharged from the liquid ejection head 2 is discharged downward in the gravity direction (that is, the −Z direction) from the discharging portion 4 via the maintenance unit 9 and supplied into the waste liquid storage chamber of the waste liquid container 5 via the waste liquid inlet 13 and the waste liquid input chamber 20.

In the liquid ejection apparatus 1 to which the waste liquid container 5 illustrated in FIG. 3A and FIG. 3B is attached, the discharging portion 4 is provided at a position relatively close to the opening 8 inside the attachment portion 3 formed as the recessed portion in the outer side surface of the liquid ejection apparatus 1. The discharging portion 4 is for supplying the waste liquid to the waste liquid container 5, and the waste liquid is attached to the surface thereof. If the discharging portion 4 is provided at a position relatively close to the opening 8, the user is likely to touch the discharging portion 4 when performing an operation to replace the waste liquid container 5, and as a result, the finger of the user or the like may be soiled with the waste liquid. The liquid ejection apparatus and the waste liquid container based on the present invention are to prevent the user from touching the waste liquid during replacement of the waste liquid container 5 or the like by arranging the position of the discharging portion 4 in the attachment portion 3 to a position that is not easily touched by the user.

### First Embodiment

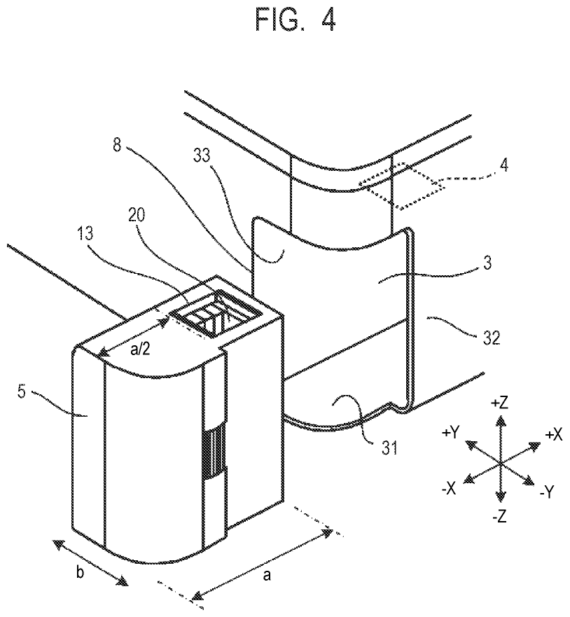

FIG. 4 illustrates the liquid ejection apparatus 1 and the waste liquid container 5 of a first embodiment of the present invention. Note that the configuration of the liquid ejection apparatus 1 is substantially the same as that illustrated in FIG. 1 to FIG. 3A and FIG. 3B except for the attachment portion 3 and the periphery thereof. Also in the present embodiment, the opening 8 for forming the attachment portion 3 is provided in adjacent two outer side surfaces of the casing 6 of the liquid ejection apparatus 1, that is, at a position connecting the outer side surface facing the −X direction and the outer side surface facing the −Y direction to each other. In the present embodiment, however, the outer side surface facing the −Y direction of the casing 6, that is, one of the outer side surfaces is formed extending in the −X direction so as to partially cover, in the −Y direction, the recessed portion forming the attachment portion 3. In the outer side surface facing the −Y direction, the portion covering the recessed portion forming the attachment portion 3 is referred to as a direction restriction member 32. In the illustrated example, the direction restriction member 32 covers approximately a half of the recessed portion. In the same manner as is illustrated in FIG. 3A and FIG. 3B, the bottom wall 31 is also formed in the attachment portion 3. By causing a part of the outer side surface forming the casing 6 to serve as the direction restriction member 32, it is possible to form the structure by which the waste liquid container 5 can move only in the +X direction during attachment while reducing the number of additional members required for forming the attachment portion 3.

Also in this embodiment, the waste liquid container 5 has substantially a rectangular parallelepiped shape having sides parallel to the X-axis, the Y-axis, and the Z-axis, respectively. In the present embodiment, however, on the liquid ejection apparatus 1 side, the attachment portion 3 is structured such that the shape thereof is defined by the bottom wall 31, the direction restriction member 32, and a side surface 33 facing the direction restriction member 32. Thus, in the present embodiment, it is required to insert the waste liquid container 5 in the +X direction to the attachment portion 3 in order to fit and attach the waste liquid container 5 to the attachment portion 3. When the direction in which the waste liquid container 5 is moved during attachment is defined as a first direction, the +X direction is the first direction in this example, and structure that restricts the direction in which the waste liquid container 5 is attached to the attachment portion 3 to the first direction, that is, restriction structure is formed. To facilitate attachment in such a direction, the waste liquid container 5 has the length “a” in the X-axis direction that is longer than the length “b” in the Y-axis direction. Further, to avoid an unnatural protrusion of the waste liquid container 5 out of the casing 6 or avoid an unnatural recess in the surface of the casing 6, the outer surfaces of the waste liquid container 5 are configured to be continuous to the outer surfaces of the casing 6 when the waste liquid container 5 is fully attached to the attachment portion 3. As a result, when the direction that is orthogonal to the first direction but is not the gravity direction is defined as a second direction, the lengths “a” and “b” of the waste liquid container 5 are respective lengths along the first direction and the second direction of a region included in the attachment portion 3 and occupied by the waste liquid container 5 fitted and attached to the attachment portion 3. Further, these lengths “a” and “b” are also respective lengths along the first direction and the second direction of a portion of the waste liquid container 5 inside the attachment portion 3 when the waste liquid container 5 has been attached to the attachment portion 3.

In the top surface of the waste liquid container 5, the waste liquid inlet 13 is opened which faces the discharging portion 4 of the liquid ejection apparatus 1 when the waste liquid container 5 has been attached to the attachment portion 3 and accepts the waste liquid discharged, for example, downward in the gravity direction from the discharging portion 4, as described above. That is, the top surface of the waste liquid container 5 in which the waste liquid inlet 13 is formed is a surface facing a direction orthogonal to both the first direction and the second direction out of the surfaces of substantially the rectangular parallelepiped waste liquid container 5. The downward in the gravity direction faced by the discharging portion 4 is a direction orthogonal to both the first direction and the second direction. Because the discharging direction of the waste liquid from the discharging portion 4 is downward in the gravity direction, it is possible to minimize the likelihood of the waste liquid spilling along the inner wall of the attachment portion 3 or the like. Further, since the first direction is orthogonal to the gravity direction, the configuration of the present embodiment is a configuration suitable for performing replacement of the waste liquid container 5 from the horizontal direction with respect to the liquid ejection apparatus 1 placed on a desk or the like.

In the present embodiment, the position of the waste liquid inlet 13 on the top surface of the waste liquid container 5 is a position on the head side in the attaching direction to the attachment portion 3 along the +X direction with respect to a position bisecting the length “a” along the +X direction of a portion located inside the attachment portion 3 when the waste liquid container 5 has been attached. Therefore, the position of the discharging portion 4 is a position on the inward side of the casing 6 along the +X direction with respect to the position bisecting the length “a” along the +X direction in the attachment portion 3 of the region occupied by the fitted and attached waste liquid container 5. With the discharging portion 4 being formed at such a position, this suppresses the user from touching the discharging portion 4 during replacement of the waste liquid container 5 or the like in the liquid ejection apparatus 1 of the present embodiment.

Although the attaching direction when the waste liquid container 5 is attached to the liquid ejection apparatus 1 is restricted to be the +X direction in the above description, the attaching direction is not limited thereto. For example, a configuration in which the waste liquid container 5 is moved only in the +Y direction may be employed. In such a case, the first direction is the +Y direction, and the second direction is the +X direction. Further, the discharging portion 4 is provided at a position on the inward side of the casing 6 along the +Y direction with respect to the position bisecting the length along the +Y direction of the region occupied by the attached waste liquid container in the attachment portion 3.

### Second Embodiment

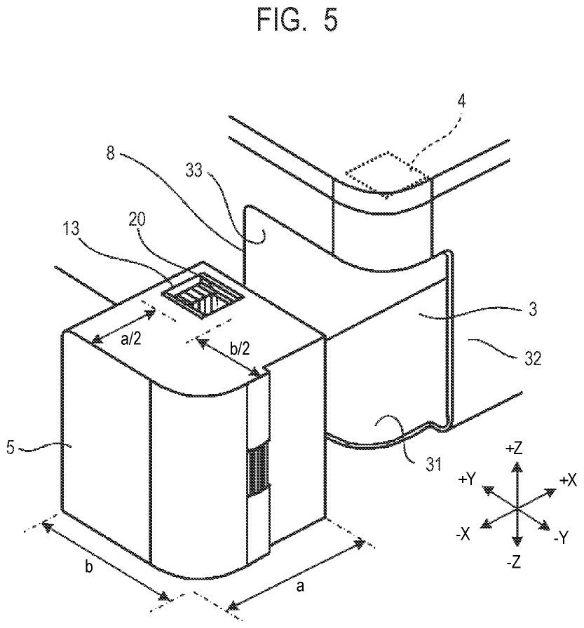

Next, the liquid ejection apparatus 1 and the waste liquid container 5 of a second embodiment of the present invention will be described with reference to FIG. 5. Also in the second embodiment, the X-axis, the Y-axis, and the Z-axis are defined and the first direction and the second direction are defined in the same manner as in the first embodiment, and the shapes of the liquid ejection apparatus 1 and the waste liquid container 5 are the same as those in the first embodiment. In the second embodiment, however, the length “b” in the Y-axis direction of the waste liquid container 5 is longer than that in the first embodiment, and the relationship of a>b is not necessarily required to be met. Further, in the second embodiment, the position of the waste liquid inlet 13 in the top surface of the waste liquid container 5 is a position closer to the inside of the casing 6 during attachment. The position of the waste liquid inlet 13 and the position of the discharging portion 4 corresponding thereto in the second embodiment will be described below.

In the same manner as in the first embodiment, regarding a portion of the attached waste liquid container 5 located inside the attachment portion 3, the waste liquid inlet 13 is provided at a position on the inward side of the casing 6 along the +X direction with respect to the position bisecting the length “a” along the +X direction of the portion. Furthermore, regarding a portion of the waste liquid container 5 located inside the attachment portion 3 in a state where the waste liquid container 5 is attached to the attachment portion 3, the position of the waste liquid inlet 13 is also a position on the inward side of the casing 6 along the +Y direction with respect to the position bisecting the length “b” along the +Y direction of the portion. In accordance with the above, the discharging portion 4 is provided at a position that is in the attachment portion 3 and is on the inward side of the casing 6 along the +X direction with respect to the position bisecting the length “a” along the +X direction of a region occupied by the attached waste liquid container 5. Furthermore, the position of the discharging portion 4 is also a position on the inward side of the casing 6 along the +Y direction with respect to the position bisecting the length “b” along the +Y direction of the region occupied by the attached waste liquid container 5. In the present embodiment, by setting the positions of the discharging portion 4 and the waste liquid inlet 13 in such a way, it is possible to reduce the likelihood of the user touching the discharging portion 4 during replacement of the waste liquid container 5 or the like even when the length “b” in the Y-axis direction is longer for increasing the capacity of the waste liquid container 5.

### Third Embodiment

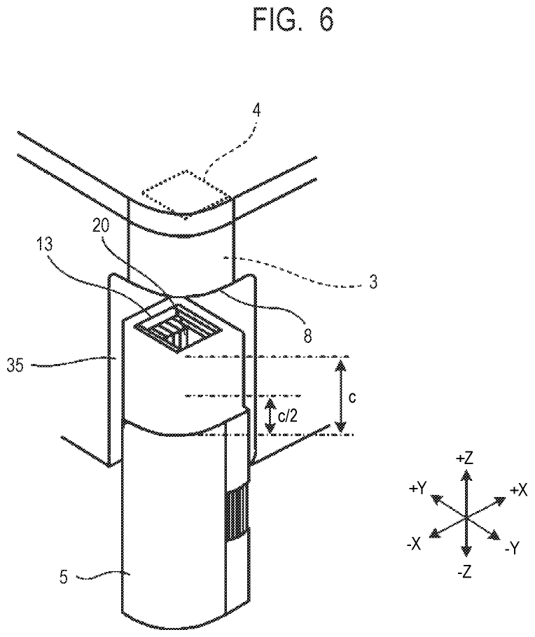

Next, the liquid ejection apparatus 1 and the waste liquid container 5 of a third embodiment of the present invention will be described with reference to FIG. 6. Also in the third embodiment, the X-axis, the Y-axis, and the Z-axis are defined, and the first direction and the second direction are defined in the same manner as in the embodiments described above. However, although the moving direction of the waste liquid container 5 when being attached to the attachment portion 3 is restricted to be the +X direction in the embodiments described above, the moving direction of the waste liquid container 5 is restricted to be the +Z direction, and the +Z direction is the first direction in this embodiment. Although the feature in which the attachment portion 3 to which the waste liquid container 5 is fitted and attached in a detachable manner is formed at a position where adjacent two outer surfaces of the casing 6 are connected to each other is the same as that of the embodiments described above, the opening 8 forming the end of the attachment portion 3 is opened in the −Z direction in this embodiment. In more details, a hollowed recessed groove 35 extending in the +Z direction from the bottom of the casing 6 is provided at a position where the adjacent outer surfaces of the casing 6 connect to each other, and the position of the upper end of the recessed groove 35 corresponds to the opening 8. In a part above, in the +Z direction, from the position of the opening 8, the adjacent two outer side surfaces of the casing 6 connect to each other without being hollowed, and the region surrounded by the adjacent two outer side surfaces corresponds to a recess formed for the attachment portion 3. In the recess formed for the attachment portion 3, the opening 8 thereof is provided downward in the gravity direction, and the discharging portion 4 is provided at the upper end of the recess.

In the present embodiment, the waste liquid container 5 has substantially a rectangular parallelepiped shape elongated in the Z-axis direction, that is, a quadrangular cylinder shape, and the end side in the +Z direction is formed thinner than the remaining portion in order to be fitted and attached to the attachment portion 3 in a detachable manner. The length in the Z-axis direction of this portion formed thinner is defined as “c”. The length “c” is the length along the +Z direction of a portion of the waste liquid container 5 inside the attachment portion 3 when the waste liquid container 5 has been attached to the attachment portion 3 and also is the length along the +Z direction of a region occupied by the waste liquid container 5 fitted and attached to the attachment portion 3 in the liquid ejection apparatus 1. In the waste liquid container 5, the waste liquid inlet 13 is formed in a surface facing the +Z direction of the end in the +Z direction of the waste liquid container 5. In such a case, the position of the waste liquid inlet 13 of the waste liquid container 5 satisfies a condition of being at a position on the inward side of the casing 6 along the +Z direction with respect to the position bisecting the length “c” along the +Z direction of the portion located inside the attachment portion 3 in an attached state. Further, the position of the discharging portion 4 in the liquid ejection apparatus 1 also satisfies a condition of being, in the attachment portion 3, a position on the inward side of the casing 6 along the +Z direction with respect to the position bisecting the length “c” along the +Z direction of the region occupied by the waste liquid container 5 attached to the attachment portion 3. According to the present embodiment, since the discharging portion 4 is provided in the deepest part in the attaching direction when the waste liquid container 5 is attached to the attachment portion 3, it is possible to reduce the likelihood of the user touching the discharging portion 4 during replacement of the waste liquid container 5 or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-004211, filed Jan. 15, 2020, which is hereby incorporated by reference herein in its entirety.

What is claimed is:

1. A liquid ejection apparatus comprising:
a casing;
a liquid ejection head that ejects a liquid; and
an attachment portion to which a waste liquid container used for storing a waste liquid discharged from the liquid ejection head is fitted and attached in a detachable manner,
wherein the attachment portion comprises an opening formed in an outer side surface of the casing and a recess continuous with the opening and is structured such that an attaching direction of the waste liquid container when the waste liquid container is being attached to the attachment portion is defined as a first direction,
wherein in the attachment portion, a discharging portion used for outputting the waste liquid to the waste liquid container is formed at a position on an inward side of the casing along the first direction with respect to a position bisecting a length along the first direction of a region occupied by the waste liquid container fitted and attached to the attachment portion, and
wherein the discharging portion faces a direction orthogonal to the first direction.

2. The liquid ejection apparatus according to claim 1,
wherein the casing has substantially a rectangular parallelepiped shape, and the opening is formed at a position where adjacent two outer side surfaces of the casing connect to each other, and
wherein one of the adjacent two outer side surfaces extends so as to partially cover the recess, and
wherein the first direction is a direction parallel to the one of the outer side surfaces.

3. The liquid ejection apparatus according to claim 2,
wherein a position of the discharging portion in a second direction orthogonal to the first direction is on an inward side of the casing along the second direction with respect to a position bisecting a length of the region along the second direction, and
wherein the discharging portion faces a direction orthogonal to both the first direction and the second direction.

4. The liquid ejection apparatus according to claim 1, wherein the discharging portion faces downward in the gravity direction.

5. A waste liquid container configured to be fitted and attached in a detachable manner to an attachment portion by being inserted in a first direction to the attachment portion of a liquid ejection apparatus that ejects a liquid and to store a waste liquid discharged from the liquid ejection apparatus,
wherein the attachment portion is formed as a recess opened in a casing of the liquid ejection apparatus,
wherein a waste liquid inlet that accepts the waste liquid from the liquid ejection apparatus is opened at a position on an inward side of a casing along the first direction with respect to a position bisecting a length along the first direction of a portion of the waste liquid container located inside the attachment portion in a state where the waste liquid container is attached to the attachment portion, and
wherein the waste liquid inlet is provided in a surface of the waste liquid container facing a direction orthogonal to the first direction.

6. The waste liquid container according to claim 5 having substantially a rectangular parallelepiped shape and having an outer surface continuous to an outer side surface of a casing of the liquid ejection apparatus in a state where the waste liquid container is attached to the attachment portion.

7. The waste liquid container according to claim 6,
wherein a position of the waste liquid inlet in a second direction orthogonal to the first direction is a position on an inward side of the casing along the second direction with respect to a position bisecting a length of the portion along the second direction in a state where the waste liquid container is attached to the attachment portion, and
wherein the waste liquid inlet is provided in a surface of the waste liquid container facing a direction orthogonal to the first direction and the second direction.
